(19) United States
(12) Patent Application Publication
(10) Pub. No.: US 2024/0351275 A1
(43) Pub. Date: Oct. 24, 2024

(54) 3D PRINTING RETRACTABLE SLIP FORM

(71) Applicant: Walter Rebsch, Vancouver, WA (US)

(72) Inventor: Walter Rebsch, Vancouver, WA (US)

(21) Appl. No.: 18/138,324

(22) Filed: Apr. 24, 2023

(51) Int. Cl. B29C 64/194; B33Y 40/20

(52) U.S. Cl. CPC B29C 64/194; B33Y 40/20; B29C 64/209

(57) ABSTRACT

3D printed objects have imperfections that result in small ridges or horizontal stripes on any model that is printed. A trowel like arm known as a slip form is affixed near the print head to allow for the models to have a more perfect finish. This retractable slip form helps prevent the small ridges and horizontal stripes that form during the printing process.

### FIELD OF THE INVENTION

The present subject matter relates to the imperfections of 3D printed objects.

### PRIOR ART

Current surface finishing techniques involve post processing of the printed object rather than forming the surface finish when it's created. For example, a machine tool may move along the surface to smooth it, or a hot plate that would remelt the surface to smooth it, or a device to spray some sort of coating on the surface to change its appearance.

Currently, most 3D printed parts are left “as is” with the surface texture that is created by the progressive building of the object layer by layer. No efforts are made to improve the surface finish or texture from its appearance as first extruded by the printer.

The present subject matter would allow 3D printed objects to more closely resemble traditionally built objects. In the case of metal parts created for machines, it would allow higher performance of the resulting object with a smoother finish.

### SUMMARY OF THE INVENTION

Currently, when 3D printing an object, the resulting object will have a surface texture with a series of small ridges or stripes in the direction that the print head moved as it prints the objects. Thus, the final object will have a distinctive look that only 3D printed objects have.

The smaller the amount of material deposited per pass, the smaller the ridges will be. However, the finished object will always have these lines running horizontally left on the object.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to rotate about the other object.

As described herein, the term “slip form” shall be used to describe a flat plate placed exactly adjacent to the location a newly printed surface will be that such that the extruded material from the print head can press against the flat plate forming a new surface that will be exposed when the slip form is moved along the newly printed material.

As described herein, the term “extended” shall be used to describe a position that is just vertically below the opening of the print head nozzle and immediately adjacent to the location of the newly deposited material.

As described herein, the term “retracted” shall be used to describe a position vertically above the bottom edge of the print head nozzle.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include hardware components or modules that, for purposes of discussion, may be illustrated and described as if the majority of the components were implemented solely in hardware. It should be noted that a plurality of hardware devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present subject matter comprises of a slip form, pivotally connected to the print head, hereafter referred to as the “slip form”. The slip form is positioned to form a barrier for the newly extruded material to mold against as it is extruded.

When the print head reaches an edge of the newly created part, the slip form will rotate to align tangentially with the exterior surface of the new surface and will extend down exactly beside the print nozzle to create a surface that the extruded material will be deposited against leaving a smooth texture on the outside of the object.

In some embodiments, where the print material is kept liquid using heat, the slip form will be passively or actively cooled to allow the material to be firm enough to not sag as the form is moved.

As the print head moves, the retractable barrier will slide along the new surface of the printed object. This type of form is commonly called a “slip form” and is also used in highway construction to form concrete medians and other areas where an extruded shape needs to be produced.

The form is moved along as you add material leaving behind a shaped surface.

The slip form can be attached to the rotating mount such that it can be moved laterally in either direction tangentially to the nozzle opening of the extruder. This will allow surfaces to be smoothed all the way to a corner when the printed object has sharp corners.

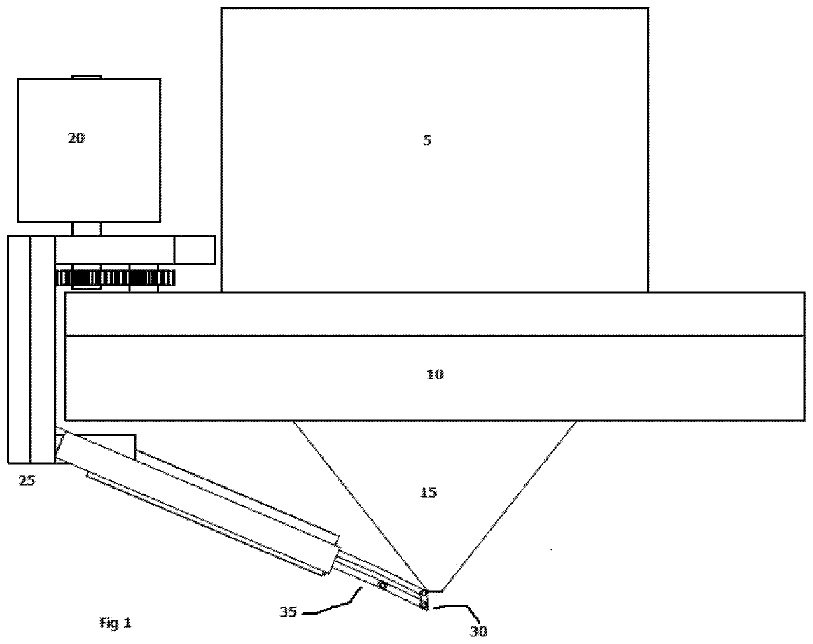

FIG. 1 shows the whole print head as the nozzle frame 5 enclosed by the rotational guide track 10. Above guide track 10 is concentric around the print head 5 and print nozzle 15 and allows the entire slip form assembly (parts 20-35) to rotate around the print head 5. The slip form bracket 25 holds the motor and the slip form extension arm 35. The slip form extension arm 35 can extend and retract the slip form 30 while also being able to tilt the slip form 30 towards or away from the opening below the print head nozzle 15.

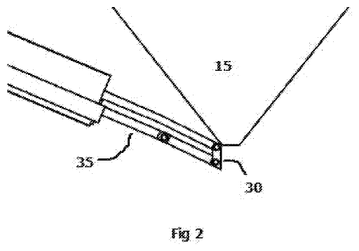

FIG. 2 shows the print head nozzle 15 with a slip form 30 extended with an actuator arm 35 to a position directly below and beside the print head.

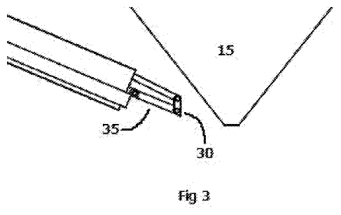

FIG. 3 shows the print head with a slip form actuator 35 retracted so that the slip form 30 is vertically above the level of the print head nozzle 15.

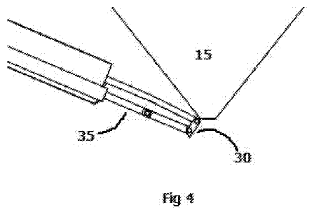

FIG. 4 shows the slip form in the extended position with the slip form actuator 35 moved so as to tilt the bottom of the slip form 30 away from directly below and beside the print head nozzle 15.

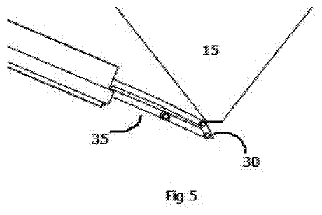

FIG. 5 shows the slip form in the extended position with the slip form actuator 35 moved so as to tilt the bottom of the slip form 30 is extended underneath the print head nozzle 15.

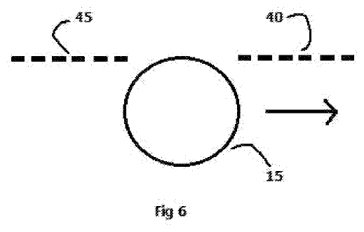

FIG. 6 shows the print head nozzle 15 opening from below and the arrow indicates the direction of motion. The slip form 40 with a lateral shift tangentially in the direction of motion. The slip form 45 with a lateral shift tangentially behind the direction of motion.

In some embodiments, the present subject matter replaces the smooth flat surface of the slip form with an actively controlled surface similar to the head of a dot matrix printer, but with at least one column of pins on each side of the slip form.

As the slip form is moved laterally along the outside edge of the object during printing the column of small pins on the trailing side of the active slip form will move into and out of the surface pressing against the newly printed material creating a surface texture on the final object in a pattern programmed by the controlling software.

In some embodiments, fine detail in the surface texture would require a print head to have very fine pins to recreate a texture with small surface features, in others the number of pins would be only a few to create coarser textures.

The present subject matter may have two or more separate rotating retractable slip forms attached to a single print nozzle so as to finish both the inside and outside surfaces simultaneously of an object if desired.

In some embodiments, the texturing pins would instead be a vertical row of small holes for compressed air to be blown through. Depending on the amount of air and pressure sent down each hole it would displace more or less of the newly deposited material.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. A 3D printing device comprising of a print head, a retractable slip form, print nozzle, rotation assembly, and printing material.

2. The 3D printing device comprising of the print head, the retractable slip form, print nozzle, rotation assembly, and printing material as in claim 1, wherein the retractable slip form is precisely positioned beside the desired edge of the final product when extended.

3. The 3D printing device comprising of the print head, the retractable slip form, print nozzle, rotation assembly, and printing material as in claim 2, wherein the retractable slip form can be tilted underneath the nozzle or away from it so as to form a surface that is not exactly vertical.

4. The 3D printing device comprising of the print head, the retractable slip form, print nozzle, rotation assembly, and printing material as in claim 2, wherein the retractable slip form can be moved laterally when forming corners.

5. The 3D printing device comprising of the print head, the retractable slip form, print nozzle, rotation assembly, and printing material as in claim 2, wherein the printing material is kept semi-liquid in the print head with heat using a heating element in the print head;

6. The 3D printing device comprising of the print head, the retractable slip form, print nozzle, rotation assembly, printing material and slip form tilting mechanism as in claim 5, wherein the printing material is kept semi-liquid in the print head with heat using a heating element in the print head;

7. The 3D printing device comprising of the print head, the retractable slip form, print nozzle, rotation assembly, heating element, and printing material as in claim 6, wherein the retractable slip form may be cooled to prevent the printing material from staying liquid too long.

8. A 3D printing device comprising of a print head, a retractable slip form, print nozzle, rotation assembly, printing material, and controllable patterning pins mounted in the slip form.

9. The 3D printing device comprising of the print head, the retractable slip form, print nozzle, rotation assembly, flat plate, printing material, and controllable patterning pins as in claim 8, wherein the retractable slip form is proximally affixed so that it is near to the print head when extended.

10. The 3D printing device comprising of the print head, the retractable slip form, print nozzle, rotation assembly, flat plate, printing material, and controllable patterning pins as in claim 9, wherein the flat plat is precisely positioned beside the desired edge of the final product when extended.

11. The 3D printing device comprising of the print head, the retractable slip form, print nozzle, rotation assembly, flat plate, printing material, and controllable patterning pins as in claim 9, wherein the retractable slip form can be moved laterally when forming corners.

12. The 3D printing device comprising of the print head, the retractable slip form, print nozzle, rotation assembly, flat plate, printing material, and controllable patterning pins as in claim 8, wherein the printing material is kept semi-liquid in the print head with a heating element.

13. The 3D printing device comprising of the print head, the retractable slip form, print nozzle, rotation assembly, flat plate, heating element, printing material, and controllable patterning pins as in claim 8, wherein the retractable slip form and pins may be cooled to prevent the printing material from staying liquid too long.
